(19) United States
(12) Patent Application Publication
(10) Pub. No.: US 2004/0079400 A1
(43) Pub. Date: Apr. 29, 2004

(54) Dishwasher having a variable speed circulation pump controlled responsive to sensed turbidity

(76) Inventor: Raymond A. Young, Kinston, NC (US)

Correspondence Address: PEARNE & GORDON LLP, 1801 EAST 9TH STREET, SUITE 1200, CLEVELAND, OH, 44114-3108, US

(21) Appl. No.: 10/280,357

(22) Filed: Oct. 25, 2002

(51) Int. Cl. B08B 3/00

(52) U.S. Cl. 134/57 D

(57) ABSTRACT

A dishwasher includes an enclosure within which dishes are washed with a wash liquid. A pump moves the wash liquid to wash the dishes within the enclosure. The pump has a plurality of operational states. A sensor senses turbidity within the wash liquid. The dishwasher includes means to control the operational state of the pump in response to the sensed turbidity.

### FIELD OF THE INVENTION

The present invention relates to dishwashers, and particularly relates to dishwashers that sense turbidity of washing liquid within the dishwasher.

### BACKGROUND OF THE INVENTION

The soil removing ability of a dishwasher is related to the hydraulic force and/or volume of washing fluid that is applied to the dishes that are to be washed. Hydraulic force and/or volume are related to the size, operating capacity, etc. of the pump moving the washing fluid. Typically, a specific level of hydraulic force and/or volume output from a pump has an associated level of output noise and energy consumption by the pump.

### SUMMARY OF THE INVENTION

In accordance with one aspect, the present invention provides a dishwasher that includes an enclosure within which dishes are washed with a wash liquid. A pump moves the wash liquid to wash the dishes within the enclosure. The pump has a plurality of operational states. A sensor senses turbidity within the wash liquid. The dishwasher includes means to control the operational state of the pump in response to the sensed turbidity.

In accordance with another aspect, the present invention provides a dishwasher that includes an enclosure within which dishes are washed with a wash liquid. A pump moves the wash liquid. The pump has a plurality of fluid flow output rates. A sensor senses turbidity within the wash liquid. The dishwasher includes means to control the output flow rate of the pump in response to the sensed turbidity.

### BRIEF DESCRIPTION OF THE DRAWINGS

The forgoing and other features and advantages of the present invention will become apparent to those skilled in the art to which the present invention relates upon reading the following description with reference to the accompanying drawings, wherein:

FIG. 1 is a schematic illustration of a dishwasher having a variable speed circulation pump and a turbidity sensor for use in control of the pump in accordance with the present invention; and

FIG. 2 is a flow chart for a process in accordance with the present invention.

### DESCRIPTION OF EXAMPLE EMBODIMENT

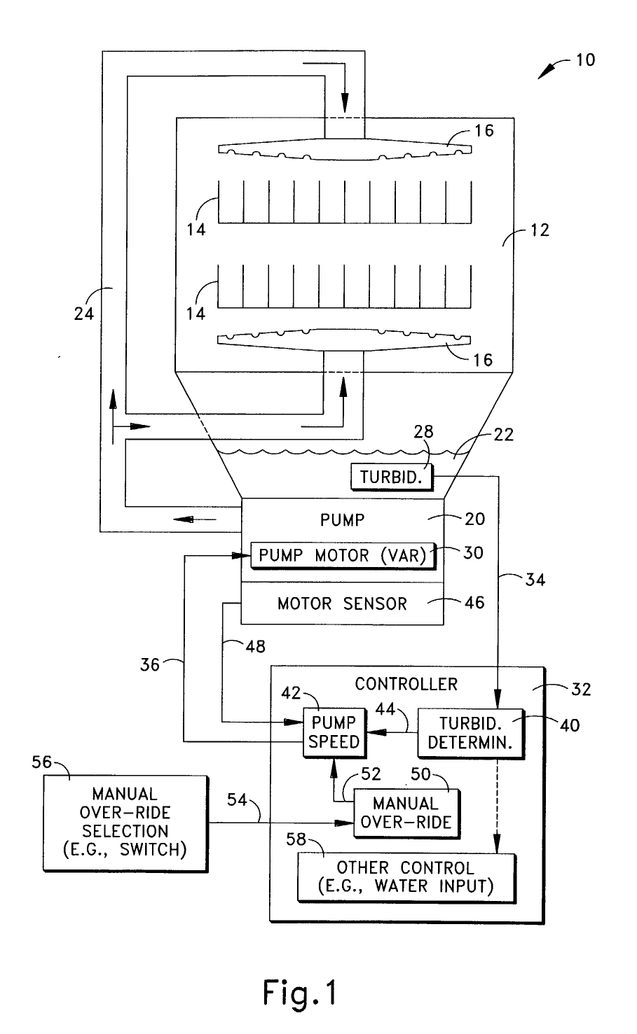

One example of dishwasher 10, in accordance with the present invention, is schematically shown in FIG. 1. The dishwasher 10 has an enclosure 12 within which dishes (e.g., plates, cups, bowls, tableware, pots, pans, etc.) are placed for cleaning. In the illustrated example, the dishwasher 10 has racks 14 for supporting the dishes. Also, the dishwasher 10 has washing liquid (e.g., water and detergent) delivery components 16, such as spray heads or spray arms. The dishwasher 10 may have other and/or different structure(s).

During operation, the washing liquid is circulated within the dishwasher 10 via a pump 20. In the shown example, the pump 20 draws the wash liquid from a sump area 22 (e.g., a low area of the enclosure 12) and supplies the wash liquid, via connecting hoses/pipes 24 to the delivery components 16. In turn the wash liquid is applied to the dishes via the delivery components 16 and subsequently falls to the sump area 22. The wash liquid undergoes a plurality of circulations.

During the washing of the dishes, particulate matter (e.g., food residue) is washed from the dishes and is carried away from the dishes by the wash liquid. The particulate matter provides a level of turbidity within the washing liquid. Hereinafter, the particulate matter level within the washing liquid is referred to as turbidity. The turbidity may be indicative of the level of cleanness of the dishes. It has been appreciated by the inventor that cleaning of dishes is affected by the volume and/or pressure of the wash liquid applied to the dishes. Also, it has been appreciated by the inventor that energy consumption and output noise levels are related to pump operation.

In accordance with the present invention, the volume and/or pressure of the wash liquid applied to the dishes is changed in response to the turbidity of the washing liquid. Specifically, the pump 20 is configured to have a plurality of operational states that each provides a different output flow rate (e.g., flow volume and/or speed) of the wash liquid. The output flow rate can also be considered in terms of hydraulic pressure. A turbidity sensor 28 senses the turbidity of the wash liquid. The sensed turbidity 28 is used to control the operational state of pump 20.

In the shown example, the pump 20 includes a pump motor 30 that has a plurality of operation speeds. As such, the motor 30 is referred to as a variable speed motor In particular, the motor 30 has at least two speeds (e.g., low and high). In one example, a low speed would be for very quiet washing and the high speed would be for ultra scrubbing power.

A controller 32 is operatively connected 34 to the turbidity sensor 28, to receive a signal indicative of the sensed turbidity. The controller 32 is operatively connected 36 to the pump motor 30 to control the pump motor in response to the sensed turbidity. The controller 32 may have any suitable construction and configuration for controlling the motor 30 in response to the sensed turbidity. In the shown example, the controller 32 has a portion 40 for determining the turbidity level using the signal from the turbidity sensor 28. A portion 42 of the controller 32 controls pump speed, and is operatively connected 42 to the turbidity level determination portion 40 and operatively connected 36 to the pump motor 30. In the shown example, a motor sensor 46 (e.g., a Hall effect sensor) senses the operation speed of the motor 30 and is operatively connected 48 to the pump speed determination portion 42. As such, a feedback or monitor aspect can be utilized in the control of the pump speed.

In the shown example, a manual override portion 50 of the controller 32 is operatively connected 52 to the pump speed control portion 42. The manual override portion 50 is operatively connected 54 to a manual override selection component 56 (e.g., a selection switch). A manual override allows a user to select pump speed that is not dependent upon the sensed turbidity level.

It is to be appreciated the controller 32 may have over components and/or functions. Specifically, in the shown example, the controller 32 has portion(s) 58 that utilize the determined turbidity level to control other aspects of the dishwasher. For example, the turbidity level may be utilized to determine whether to input fresh water.

Turning to the determination(s) that are utilized for changing operational speed of the pump motor 30, it is to be appreciated that any suitable determination(s) may be utilized. For example, a determination of whether the turbidity level has exceed a preset threshold may be used.

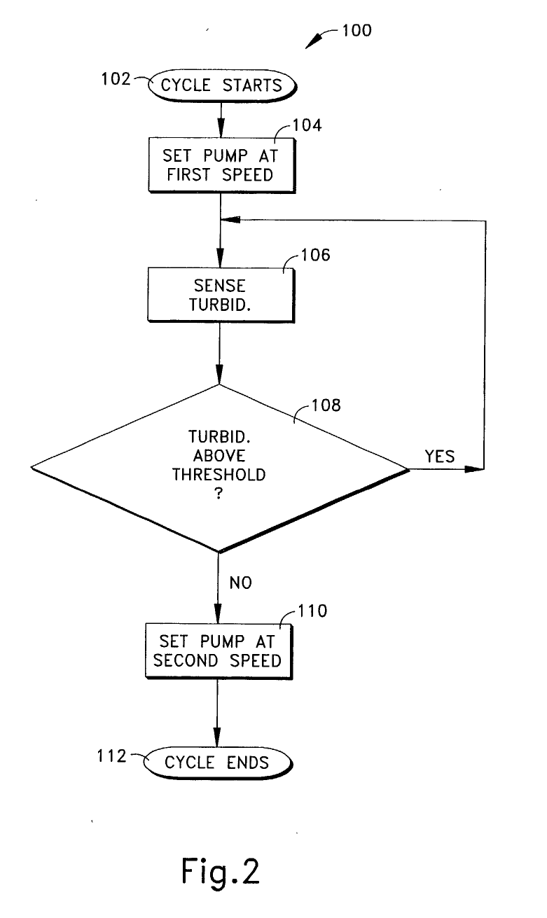

An example of a process performed by the dishwasher of FIG. 1, in accordance with the present invention, is shown in FIG. 2. The process 100 is initiated at step 102 and proceeds to step 104. At step 104 the pump is operated at a first speed. At step 106, the turbidity is sensed. At step 108, it is determined in the turbidity is above a threshold value.

If the determination at step 108 is affirmative (i.e., the turbidity is above the threshold), then the process 100 loops to step 106. The pump speed is not changed, and the turbidity is again sensed, at step 106, and compared to the threshold, at step 108.

If the determination at step 108 is negative (i.e., the turbidity is at or below the threshold), the process proceeds to step 110. At step 110, the pump is set to a second speed. The process 100 ends at set 112.

From the above description of the invention, those skilled in the art will perceive improvements, changes and modifications. Such improvements, changes and modifications within the skill of the art are intended to be covered by the appended claims.

What is claimed is:

1. A dishwasher including:
an enclosure within which dishes are washed with a wash liquid;
a pump for moving the wash liquid to wash the dishes within the enclosure, the pump having a plurality of operational states;
a sensor for sensing turbidity within the wash liquid; and
means to control the operational state of the pump in response to the sensed turbidity.

2. A dishwasher as set forth in claim 1, wherein the pump has a plurality of fluid flow output rates as the plurality of operational states.

3. A dishwasher as set forth in claim 1, wherein the pump includes a motor that has a plurality of motor speeds as the plurality of operational states.

4. A dishwasher as set forth in claim 2, wherein the pump is operated at one motor speed when the sensed turbidity is above a threshold level, and the pump is operated at another motor speed when the sensed turbidity is below the threshold level.

5. A dishwasher including:
an enclosure within which dishes are washed with a wash liquid;
a pump for moving the wash liquid, the pump having a plurality of fluid flow output rates;
a sensor for sensing turbidity within the wash liquid; and
means to control the output flow rate of the pump in response to the sensed turbidity.

6. A dishwasher as set forth in claim 5, wherein the pump is for moving the wash liquid to wash the dishes within the enclosure.
